(19) United States
(12) Patent Application Publication
(10) Pub. No.: US 2005/0244586 A1
(43) Pub. Date: Nov. 3, 2005

(54) Method for impregnation of matters in wood utilizing sound vibration energy

(76) Inventor: Sun-Tae An, Geumjung-Gu (KR)

Correspondence Address: ST. ONGE STEWARD JOHNSTON & REENS, LLC, 986 BEDFORD STREET, STAMFORD, CT, 06905-5619, US

(21) Appl. No.: 11/154,605

(22) Filed: Jun. 16, 2005

Related U.S. Application Data
(63) Continuation of application No. PCT/KR04/00019, filed on Jan. 8, 2004.

(30) Foreign Application Priority Data
Jan. 14, 2003 (KR) 10-2003-0002302

(51) Int. Cl. G10D 3/00; G21H 1/00; B01J 19/08; H01F 41/00; G21H 5/00

(52) U.S. Cl. 427/457

(57) ABSTRACT

Disclosed is a method for impregnation of matters in wood utilizing sound vibration energy. The impregnation method is to impregnate specific functional matters or specific color paints into a semi-finished wood processed in the fiber direction or in the rectangular fiber direction. Impregnation fluid is coated on the surface of the semi-finished wood relatively thin, and the vibration generating surface of a sound vibration generator is located inside the impregnation fluid. At this time, the sound vibration generator is separated from the surface of the semi-finished wood at a predetermined interval and applies ultrasonic vibration. The impregnation method is economical as using the low-volume sound vibration generator, uses the minimized amount of the impregnation fluid, performs the impregnation work to a deep portion of the semi-finished wood, and maximizes impregnation efficiency as applying the sound vibration energy at the optimum angle when the surface of the semi-finished wood is in the fiber direction or the rectangular fiber direction.

This application is a continuation of pending International Patent Application No. PCT/KR2004/000019 filed Jan. 8, 2004 which designates the United States and claims priority of Korean Patent Application No. 2003-2302 filed Jan. 14, 2003.

### FIELD OF THE INVENTION

The present invention relates to a method for impregnation of matters in wood utilizing sound vibration energy, and more particularly, to an impregnation method, which can penetrate various matters (fire-proof materials, coagulation fluid for reinforcing wood quality, specific color paints, and so on), which are used for keeping and decoration of wood using ultrasonic energy.

### BACKGROUND ART

Sound vibrations have been expanded in technical area to impregnation technology, to which physical and chemical processes are combined, as studies and developments related with the sound vibrations have been diversified. Furthermore, the studies of sound vibrations are progressing actively to impregnate specific matters into materials such as wood.

The use of the sound energy is well-known as the most effective technology in impregnation of the specific matters into wood because the matters are impregnated into wood in a good condition.

Russian Patent No. 2010701(issued on 1994) discloses a technology for impregnating specific matters into wood using ultrasonic energy.

The prior art is that solution is charged into a material (i.e., wood) to be processed, DC power source is applied, and at the same time, strong ultrasonic vibration is applied to the material.

When weight of wood is reduced to 6-12%, the solution is compressed into the wood while frequency and amplitude condition of an ultrasonic generator are changed.

However, the above method is very difficult in process and requires lots of impregnation time as comprising a lot of steps and controlling ultrasonic frequency and amplitude while inspecting various characteristics.

Meanwhile, Russian Patent No. SU 677038 (issued on 1991) discloses a technology for impregnating specific matters into a porous material, namely wood, using sound vibration energy.

In the prior art, a semi-finished product to be processed is charged into a chamber, a sound vibration generator is mounted inside the chamber, and a plate is oppositely located inside the chamber.

The semi-finished wood is located between the sound vibration generator and the plate, the chamber is filled with impregnation fluid, and then, sound vibration energy is applied to the whole impregnation fluid.

Such method requires an exact control of frequency ad a system for keeping uniform frequency during a penetration period. Moreover, the prior art has another problem in that it requires lots of impregnation fluid as the impregnation fluid is charged into the chamber.

### DISCLOSURE OF INVENTION

Accordingly, the present invention is directed to an improved method for impregnation of matters in semi-finished wood that substantially obviates one or more problems due to limitations and disadvantages of the related art.

Particularly, an object of the present invention is to provide a method for impregnation of matters in wood utilizing sound vibration energy, which can allow very economical impregnation work in comparison with the typical impregnation methods.

### BRIEF DESCRIPTION OF DRAWINGS

Further objects and advantages of the invention can be more fully understood from the following detailed description taken in conjunction with the accompanying drawings in which:

FIG. 1 is a perspective reference view showing a preferred embodiment of the present invention; and

FIG. 2 is a perspective reference view showing a preferred embodiment of the present invention.

### DETAILED DESCRIPTION OF PREFERRED EMBODIMENTS

A method for impregnation of matters in wood utilizing sound vibration energy according to the present invention provides the following characteristics.

That is, a sound vibration generator is used for applying sound vibration energy to specific impregnation fluid to be impregnated into semi-finished wood, and the sound vibration energy generated from the sound vibration generator is located into the impregnation fluid coated on the surface of the semi-finished wood. At this time, the sound vibration energy is separated from the surface of the semi-finished wood at a predetermined interval.

The impregnation fluid coated on the surface of the semi-finished wood can be coated separately, or coated to wanted portions at any time by an impregnation fluid feeder, which is mounted through a central hole of a vibrator or around the vibrator of the sound vibration generator.

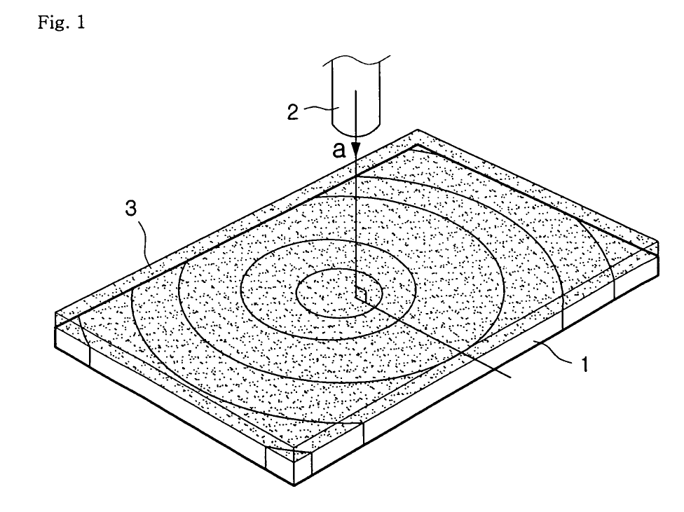

As the sound vibration energy has different transmission efficiencies according to fiber structure of wood, when specific matters are impregnated into the semi-finished wood 1, if the impregnation direction of the impregnation fluid is an “a” direction as shown in FIG. 1 (hereinafter, referred to as “fiber direction”), the sound vibration direction of the sound vibration generator 2 and the surface of the semi-finished wood 1 are at right angles to each other, so that the sound vibration direction and the surface of the semi-finished wood 1 are at an angle of zero degree.

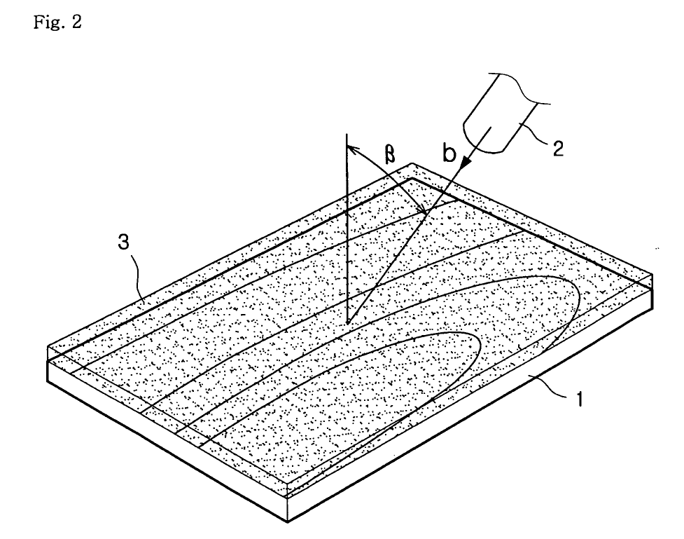

As shown in FIG. 2, if the impregnation direction of the impregnation fluid is a “b” direction (hereinafter, referred to as “rectangular fiber direction”), the sound vibration generator 2 is mounted at an angle of β degrees to the right angles of the semi-finished wood 1, and the sound vibration direction is at an angle of β degrees to the rectangular direction of the semi-finished wood 1,
wherein β is

$$β \approx sin - 1 \frac{{C}_{1}}{0.9 Cw} .$$

In the above numerical formula, C₁ is ultrasonic transmission speed (longitudinal wave) to the impregnation fluid, and C_{w} is ultrasonic transmission speed (surface wave) to the wood.

The frequency and amplitude of the sound vibration generator are determined on the basis of resonance conditions of the impregnation fluid used during an impregnation process.

In the present invention, to impregnate the impregnation fluid into the semi-finished wood using sound vibration energy, the sound vibration energy is irradiated to an impregnation fluid layer 3 coated on the semi-finished wood 1.

The maximum thickness of the impregnation fluid layer 3 is determined according to coagulation force and viscosity of the impregnation fluid, and it is preferable that the thickness of the impregnation fluid layer 3 does not exceed 5 mm. After all, in the impregnation method according to the present invention, the sound vibration energy is applied to a relatively thin layer.

If sound vibration is carried out near to the border area between a solid and a liquid, as it is applied to a small volume of the thin layer of the impregnation fluid, the sound vibration generator can concentrate the sound vibration even by small energy, and thereby, the present invention can realize a low-volume sound vibration generator and is economical.

Furthermore, the impregnation fluid of a small amount is used; the use of the impregnation fluid can be minimized.

Moreover, the impregnation fluid can be impregnated deeply into the semi-finished wood as the sound vibration passes the thin liquid layer and is transmitted into the semi-finished wood.

The sound vibration generator is mounted with the predetermined interval between the sound vibration generating surface and the semi-finished wood. The reason is that the surface of the semi-finished wood is damaged when the sound vibration generating surface is in direct contact with the semi-finished wood.

As a result of test by the inventor of the present invention, it has been confirmed that the impregnation fluid has penetrated into the semi-finished wood the most effectively when the sound vibration direction was equal to the fiber direction in a condition in which the processed surface of the semi-finished wood was a cross section of the fiber direction. It means that the sound vibration generator is mounted under a condition in which an angle of vector component of sound wave generated from the sound generating surface at right angles to the surface of the semi-finished wood is zero degree.

Moreover, it has been confirmed that the impregnation fluid has penetrated into the semi-finished wood effectively when horizontal and vertical sound waves were generated along the surface of the semi-finished wood in case of that the semi-finished wood was processed in the rectangular fiber direction.

It is possible under a condition in which an angle between sound wave generator vector and a perpendicular line of the semi-finished wood is

$$β \approx sin - 1 \frac{{C}_{1}}{0.9 Cw} .$$

Additionally, it has been confirmed that the impregnation fluid has penetrated into the semi-finished wood more effectively when the impregnation fluid was resonated during the impregnation process. The reason is that the processed surface of the wood is eroded and the impregnation is expanded as the impregnation fluid is bumped against the processed surface of the semi-finished wood while being decomposed into small particles near the surface of the semi-finished wood by the resonance. That is, as the small particles are struck by the resonance, and thereby, stronger impregnation work is carried out physicochemically.

The process for impregnating the specific matters into the semi-finished wood is carried out as follows.

Seat the semi-finished wood.

Coat the impregnation fluid on the semi-finished wood while a layer (The semi-finished wood is filled with the impregnation fluid or the sound vibration generator having pores is used for transmission of fluid).

Mount the sound vibration generator at the following angles according to the impregnation direction of the semi-finished wood.

Fiber direction: β=0°

Rectangular fiber direction:

$$β \approx sin - 1 \frac{{C}_{1}}{0.9 Cw}$$

(If you want to know an ultrasonic transmission speed by kinds of the impregnation fluid and kinds of the wood, please see the data sheet or make an experiment)

3-1 Mount the sound vibration generator in such a manner to sink the sound vibration generating surface into the impregnation fluid.

3-2. Control the interval between the semi-finished wood and the sound vibration generating surface.

4. Operate the sound vibration generator.

5. Inject the sound vibration to the whole processed surface of the semi-finished wood.

6. Repeat the second to fifth steps at several times to penetrate the impregnation fluid into the wanted depth. If an impregnation fluid feeder is used, control a feeding amount of the impregnation fluid properly to penetrate it into the wanted depth of the impregnation fluid.

Hereinafter, preferred embodiments of the present invention will be described.

### Embodiment 1

A test for impregnating fireproof matters into a white birch sample, which was 0.46 g/cm³ in density, 8% in humidity, and 150×45×7 mm in volume, was made.

The surface of the wood sample of 150×45 mm had the rectangular fiber direction. Antipyrine (fireproof material) was coated on the surface of the semi-finished wood to form a layer of 1 mm.

For the impregnation work, a standard electric sound transducer whose model name is PMC-15A-18 having a vibration generating surface of 1 cm² was used as the sound vibration generator.

The sound vibration generator was mounted in such a manner that the vibration generating surface was located inside the antipyrine layer and separated from the semi-finished wood at an interval of 0.5 mm.

Moreover, the sound vibration generator was inclined so that the speed vector of vibration generated from the vibration generating surface of the sound vibration generator was at an angle of β degrees to the vertical line of the surface of the semi-finished wood. The β angle was 16° by a formula.

The sound vibration generator has applied ultrasonic vibration to the inside of the impregnation fluid to be impregnated. The sound vibration frequency was 18 kHz and the amplitude of the vibration generating surface was 1 mm.

The impregnation work was performed while the sound vibration generator moved on the front surface of the semi-finished wood.

The impregnation work was performed for 5 minutes, and after the semi-finished wood was turned upside down, the impregnation work was applied to the opposed surface in the same way as the above process. Also, the opposed surface of the semi-finished wood was impregnated for 5 minutes.

An impregnation result was evaluated by a weight increase of the semi-finished wood in relation with a surface unit of the semi-finished wood, and the weight increase was 4.0×0⁻² g/cm².

To compare the impregnation result of the first embodiment according to the present invention with that of the typical impregnation method, a semi-finished wood of the same conditions as the first embodiment was impregnated in the impregnation fluid for 40 minutes. After the impregnation work, the weight increase in relation with the surface unit of the semi-finished wood was 2.8×0⁻² g/cm². So, it was confirmed that the impregnation level of the typical impregnation method was 30% lower than the first embodiment of the present invention.

### Embodiment 2

Impregnation work was performed in the same process as the first embodiment using the same wood sample as the first embodiment.

Vibration frequency of the sound vibration generator was equal to that of the first embodiment, but amplitude of the vibration generating surface was 3mm.

The impregnation fluid impregnated into the vibration generating surface of the sound vibration generator was seen even by naked eyes, and resonance for observing sound occurred.

The front and rear surfaces of the semi-finished wood were impregnated for one minute respectively. After the impregnation work, the weight increase in relation with the surface unit of the semi-finished wood was 4.6×0² g/cm². So, it was confirmed that the impregnation level of the second embodiment was increased to 15% or more in comparison with the first embodiment as the weight of the semi-finished wood was considerably increased within a short period of time.

To compare the impregnation result of the second embodiment according to the present invention with that of the typical impregnation method, the same semi-finished wood as the second embodiment was impregnated in an impregnation vessel filled with the same impregnation fluid and ultrasonic vibration was applied.

The vibration frequency of the sound vibration generator and the amplitude of the vibration generating surface were the same as the second embodiment. Resonance occurred inside the impregnation fluid under the vibration condition.

The impregnation work was performed for 5 minutes, and the weight increase in relation with the surface unit of the semi-finished wood was 3.7×0⁻² g/cm². So, it was confirmed that the impregnation level of the typical impregnation method was 20% lower than the second embodiment of the present invention.

### Embodiment 3

Impregnation work was performed using a sample of a semi-finished white birch, which was 85 mm in radius, 0.46 g/cm³ in density, 8% in humidity, and which was cut in the fiber direction to have the thickness of 20 mm.

Antipyrine was coated on a cross section of the semi-finished wood as in the first embodiment to form an impregnation fluid layer of 2 mm in thickness. For the impregnation work, the same sound vibration generator as the first embodiment was used.

The sound vibration generator was mounted in such a manner that the vibration generating surface was located separated from the semi-finished wood at an interval of 0.5 mm, and inclined in such a manner that the speed vector of vibration generated from the vibration generating surface of the sound vibration generator was at an angle of zero degree to the vertical line of the surface of the semi-finished wood.

The vibration frequency of the sound vibration generator and the amplitude of the vibration generating surface were determined as in the second embodiment. When the sound vibration generator was operated, resonance occurred in the impregnation fluid.

The impregnation work was performed while the sound vibration generator moved on the front surface of the semi-finished wood.

The impregnation work was performed for 5 minutes.

An impregnation result was evaluated by a weight increase of the semi-finished wood in relation with a surface unit of the semi-finished wood, and the weight increase was 12.0×0⁻² g/cm².

To compare the impregnation result of the third embodiment according to the present invention with that of the typical impregnation method, the same semi-finished wood as the third embodiment was impregnated in an impregnation vessel filled with the same impregnation fluid and ultrasonic vibration was applied. The vibration frequency of the sound vibration generator and the amplitude of the vibration generating surface were the same as the third embodiment.

Resonance occurred inside the impregnation fluid under the above vibration condition.

The impregnation work was performed for 5 minutes, and the weight increase in relation with the surface unit of the semi-finished wood was 8.0×0⁻² g/cm². So, it was confirmed that the impregnation level of the typical impregnation method was 33% lower than the third embodiment of the present invention.

### INDUSTRIAL APPLICABILITY

As described above, the method for impregnation of matters in wood utilizing sound vibration energy according to the present invention is to impregnate specific functional matters (fireproof matters, coagulation fluid for reinforcing materials, and so on) or specific color paints into the semi-finished wood processed in the fiber direction or in the rectangular fiber direction.

The impregnation fluid is coated on the surface of the semi-finished wood relatively thin, and the vibration generating surface of the sound vibration generator is located inside the impregnation fluid. At this time, the sound vibration generator is separated from the surface of the semi-finished wood at the predetermined interval and applies ultrasonic vibration to impregnate the impregnation fluid into the semi-finished wood.

According to the present invention, as the impregnation fluid is composed near the border area between a solid and a liquid, the sound vibration generator can concentrate sound vibration with small energy. So, the present invention is economical as using the low-volume sound vibration generator, uses the minimized amount of the impregnation fluid for the impregnation work, and performs the impregnation work to a deep portion of the semi-finished wood as the sound vibration energy is transmitted to the inside the semi-finished wood after passing the thin impregnation fluid layer.

Additionally, the present invention can maximize impregnation efficiency as applying the sound vibration energy at the optimum angle when the surface of the semi-finished wood is in the fiber direction or the rectangular fiber direction.

1. A method for impregnation of matters in wood utilizing sound vibration energy, the method comprising the steps of:
coating impregnation fluid on the surface of a semi-finished wood to form a layer; and
impregnating specific matters by locating a vibration generating surface of a sound vibration generator for generating sound vibration energy inside the impregnation fluid, and by mounting the sound vibration generator at a predetermined interval from the semi-finished wood.

2. The method according to claim 1, wherein if the impregnation surface of the semi-finished wood is a cross section (fiber direction), and speed vector of vibration generated from the sound vibration generator is at an angle of zero degree to the vertical line of the surface of the semi-finished wood.

3. The method according to claim 1, wherein if the impregnation surface of the semi-finished wood is formed along wood fiber (rectangular fiber direction), an angle of β degrees between the speed vector of vibration generated from the sound vibration generator and the vertical line of the semi-finished wood is determined by the following numerical formula:
$$β \approx sin - 1 \frac{{C}_{1}}{0.9 Cw} ,$$
wherein C₁ is ultrasonic transmission speed (longitudinal wave) to the impregnation fluid, and C_{w} is ultrasonic transmission speed (surface wave) to the wood.

4. The method according to claim 1, wherein the ranges of vibration frequency of the sound vibration generator and amplitude of the vibration generating surface are set on the basis of sound resonance of the impregnation fluid used for the impregnation.

5. The method according to claim 1, wherein the impregnation fluid is coated on a wanted area of the surface of the semi-finished wood at any time by an impregnation fluid feeder, the impregnation fluid feeder being mounted through a central hole of a vibrator or around the vibrator of the sound vibration generator.
